(19) United States
(12) Patent Application Publication
(10) Pub. No.: US 2015/0066475 A1
(43) Pub. Date: Mar. 5, 2015

(54) Method For Detecting Plagiarism In Arabic

(71) Applicants: Mustafa Imad Azzam, Amman (JO); Omar Suleiman El-Ashqar, Amman (JO); Feras Waleed Warrayat, Amman (JO); Lana Jamal Kayyali, Amman (JO); Prof. Walid Khaled Abu Salameh, Amman (JO); Prof. Issa E. Batarseh, Amman (JO)

(72) Inventors: Mustafa Imad Azzam, Amman (JO); Omar Suleiman El-Ashqar, Amman (JO); Feras Waleed Warrayat, Amman (JO); Lana Jamal Kayyali, Amman (JO); Prof. Walid Khaled Abu Salameh, Amman (JO); Prof. Issa E. Batarseh, Amman (JO)

(21) Appl. No.: 14/014,002

(22) Filed: Aug. 29, 2013

(51) Int. Cl. G06F 17/27

(52) U.S. Cl. CPC G06F 17/27
USPC 704/9

(57) ABSTRACT

The present invention provides a method for detecting plagiarism in Arabic texts including any rewording, reordering of words and phrases, and any pronoun changes. Such detection is achieved by returning all the Arabic words in the text to its original root using a stemmer, then comparing all the sentences in the submitted document with every sentence in all original documents. In the method of the present invention, the user has the ability to choose the source of plagiarism, wherein such source comprises a database, a web, or a direct matching.

### FIELD OF THE INVENTION

The present invention relates to methods for detecting plagiarism, especially to those methods used for detecting plagiarism in Arabic texts in which the user can choose the source of the plagiarism.

### BACKGROUND OF THE INVENTION

One of the major challenges in any academic work is to conquer academic dishonesty or plagiarism, which is the practice of taking someone else's work or ideas and passing them off as one's own.

For this reason, numerous conventional systems and tools for the detection of plagiarism have been presented in the prior art.

Among these conventional solutions, an online plagiarism detection website is disclosed, on which the user can sign-up and make an account, and then he can submit the document on the website. The website will check the internet, databases, and journals for detecting any plagiarism, and an in-depth plagiarism reports are automatically generated by the system and are delivered to the user. Using the system provided by this website, words and phrases are subject to synonym checking to root out even the most subtle attempts for plagiarism. The system of this website also compares the submitted document by more than one literature documents (i.e. it detects the plagiarism that may be done from multiple documents). It also works for eastern languages such as Arabic.

Another conventional solution discloses a plagiarism detection tool, in which the user should sign-up for creating an account, and provide the name of his/her academic institution along with his profession (either a teacher or a student), this can only be done if the academic institution is registered for utilizing this tool, but if the institution is not registered, the user cannot benefit from this tool until the institution is registered. After that, the user submits the document, and the tool will search for the documents which have the potential of being used as a source for any plagiarized part, and prepares a report for these documents along with the percentage of plagiarism as well as the percentage of originality of the submitted documents.

Another conventional solution discloses an online plagiarism checker having three different types of accounts from which the user can choose based on the expected benefit. This solution offers document analysis for text in any language that uses UTF-8 encoding. In order to assure the confidentiality of the checked documents, the transfer of the documents is done by Secure Socket Layers (SSL) encoding protocol. The plagiarism reports indicate the percentage of plagiarism along with a color code depending on the percentage of the plagiarism found in the documents.

The disclosed solutions and tools found in the prior art cannot detect plagiarism in Arabic texts with rewording, reordering of words, or pronoun changes.

### SUMMARY OF THE INVENTION

Therefore, it is an object of the present invention to have a method for detecting plagiarism detection in Arabic texts that can detect rewording, reordering of words, and pronoun changes.

It is an aspect of the present invention to have a method for detecting plagiarism in Arabic texts in which the user can choose the source of plagiarism including a database, a web, or a direct matching.

It is another aspect of the present invention to have a method for detecting plagiarism in Arabic texts comprising essentially the stages of inputting the document and corpus collection to be searched, checking the input document by a plagiarism detection tool, highlighting similar patterns and reporting the suspected resources, if any, and detecting if the similar patterns are properly cited or not.

In the method of the present invention, said stages are made for both the source document and for the suspicious document.

In the method of the present invention, stop words are removed and the words are stemmed using a conventional Arabic stemmer for the original and suspicious documents before evaluating such documents.

### BRIEF DESCRIPTION OF THE DRAWINGS

The invention will now be described with reference to the accompanying drawing which represents a preferred embodiment of the present invention, without restricting the scope thereof, and in which:

FIG. 1-1 is a first part of a flow chart of a method for detecting plagiarism in Arabic texts configured according to a preferred embodiment of the present invention.

FIG. 1-2 is a second part of a flow chart of a method for detecting plagiarism in Arabic texts configured according to a preferred embodiment of the present invention.

### DETAILED DESCRIPTION OF THE PREFERRED EMBODIMENT

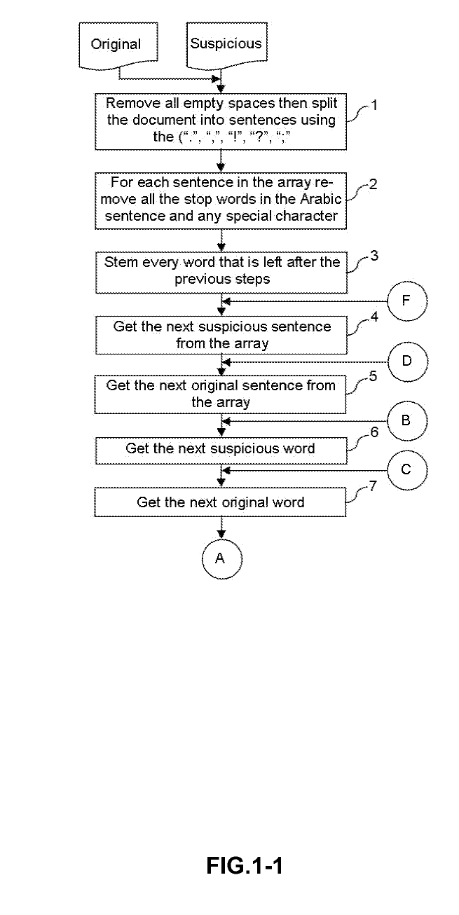

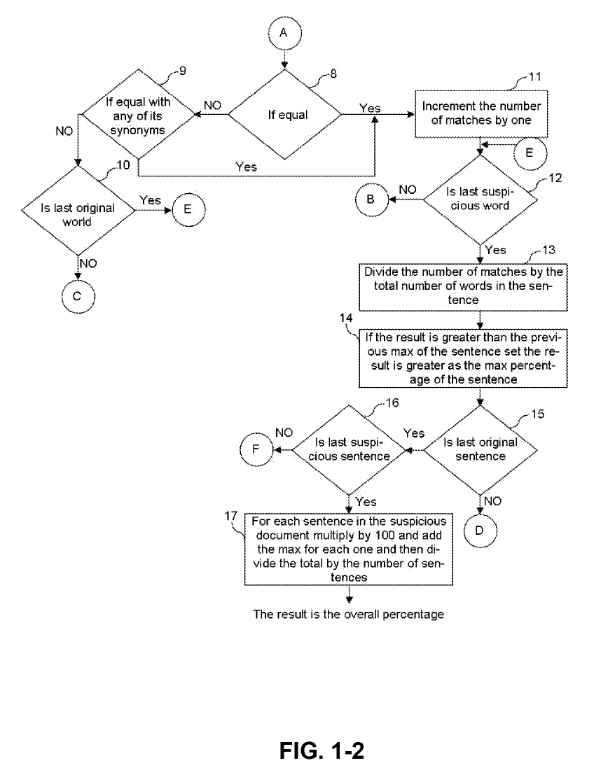

FIG. 1-1 and 1-2 illustrate a flow chart of a method for detecting plagiarism in Arabic texts. Such method comprises the steps of:
a—Removing all spaces and splitting the document into sentences using the punctuation marks (block 1);
b—Removing all stop words and all special characters for each sentence in the array (block 2);
c—Stemming every word left after the spaces, stopping words, and special characters are removed (block 3);
d—Getting the next suspicious sentence from the array (block 4);
e—Getting the next original sentence from the array (block 5);
f—Getting the next suspicious word (block 6);
g—Getting the next original word (block 7);
h—Checking if the suspicious word and the original word are equal (block 8). If the suspicious and the original words are not equal, the equality of the suspicious document with the synonyms is checked for (block 9), then if the check at block 9 is negative, a check if the original word is the last one is done (block 10). If the check at block 10 is negative, a next original word is gotten (block 7), but if the check at block 10 is positive, a check if the suspicious word is the last one is done (block 12). If the suspicious and original words are equal at block 8 or the suspicious word is equal with the synonyms at block 9, then the number of matches is incremented by one (block 11). After that, a check if the suspicious word is the last one is done (block 12). If the suspicious word is not the last one, the next suspicious word is gotten (block 6), but if the suspicious word is the last one (block 12), the number of matches is divided by the total number of words in the sentence (block 13). Thereafter, if the result of block 13 is greater than the previous maximum of the sentence, the result is set as the maximum percentage of the sentence (block 14), but if the result of block 13 is not greater than the previous maximum of the sentence, nothing will be done. And, a check if the original sentence is the last one is done (block 15), if the original sentence is the last one, a check if the suspicious sentence is the last one is done (block 16). If the original sentence is not the last one, the next original sentence is gotten from the array (block 5), and if the suspicious sentence is not the last one, then the next suspicious sentence is gotten from the array (block 4); and
i—Multiplying each sentence in the suspicious document by 100 if the result at block 16 is affirmative, and adding the maximum for each one and dividing the total by the number of sentences (block 17).

The method in the preferred embodiment of the present invention can detect any rewording, reordering of sentences and words, and pronoun changes, wherein a conventional Arabic stemmer is used to detect pronoun changes.

In the preferred embodiment of the present invention, the user has the ability to choose the source of plagiarism, wherein such source comprises a database, web, or direct matching. If the source of plagiarism was chosen to be a database, then an additional step is required in the method of the present invention, wherein such step comprises statement-based fingerprinting. In such additional step, the suspicious document is fingerprinted and the fingerprints of both suspicious and original documents are compared in order to detect plagiarism.

In the method of the present invention, the fingerprint of original documents along with its stemmed text and original text are stored in the database, wherein the original text could be a link to the place where the original text is stored. Each document stored in the database has its own title and author, wherein the title of the document is considered as a primary key.

If the plagiarism source is the web in the preferred embodiment of the present invention, each sentence in the suspicious document is split into sentences, then each of the split sentences are used as a query to the web using a suitable search engine to get 10 results, after that, all the 10 results are looped through, wherein for each duplicated URL a hit is added on, and finally, the 10 results with the highest number of hits are taken and displayed to the user.

In the preferred embodiment of the present invention, if the source for plagiarism was chosen by the user to be direct plagiarism detection, then the user enters his/her own original document, wherein both documents are compared directly after being subject to the steps of the preferred embodiment method.

In the method of the present invention, the synonyms of each word in the document is gotten from conventional synonym resources, or entered by the user in order to detect rewording.

The method of the present invention is preferably implemented in form of computer readable instructions stored on a computer readable medium executable using a computer.

While the invention has been described in details and with reference to specific embodiments thereof, it will be apparent to one skilled in the art that various additions, omissions, and modifications can be made without departing from the spirit and scope thereof.

Although the above description contains many specificities, these should not be construed as limitations on the scope of the invention but is merely representative of the presently preferred embodiment of this invention. The embodiment of the invention described above is intended to be exemplary only. The scope of the invention is therefore intended to be limited solely by the scope of the appended claims.

1. A method for detecting plagiarism in Arabic texts, and displaying the plagiarism found in texts as a percentage in which the user can choose the source of plagiarism, wherein said method comprising the steps of:
a—Removing all spaces and splitting the document into sentences using the punctuation marks;
b—Removing all stop words and all special characters for each sentence in the array;
c—Stemming every word left after the spaces, stopping words, and removing special characters using a conventional Arabic stemmer;
d—Getting the next suspicious sentence from the array;
e—Getting the next original sentence from the array;
f—Getting the next suspicious word;
g—Getting the next original word;
i—Checking if the original word is the last word in the original words and if the suspicious word is the last word in the suspicious words, and getting a next original word if the checked original word is not the last word, and getting a next suspicious word if the checked suspicious word is not the last suspicious word;
j—Dividing the number of matches between said suspicious words or their synonyms and said original words by the total number of words in said sentence;
k—Checking if the result of such division is greater than the previous maximum of the sentence, and setting the result as the maximum percentage of the sentence if such result is greater than the previous maximum percentage of the sentence, but a move to the next step will happen if such result is not greater than the previous maximum percentage of the sentence;
l—Checking if the original sentence is the last sentence in the original sentences and if the suspicious sentence is the last sentence in the suspicious, and getting a next original sentence or a next suspicious sentence if the checked sentences are not the last sentences; and
m—Multiplying each sentence in the suspicious document by 100 if the original and suspicious sentences are the last sentences, adding the maximum for each sentence, and dividing the total by the number of sentences.

2. The method of claim 1, wherein said plagiarism comprises rewording, reordering of words, and pronoun changes.

3. The method of claim 1, wherein said source for plagiarism comprises a database, a web, or a direct source.

4. The method of claim 1, wherein said method further comprises fingerprinting the suspicious document and comparing the fingerprint of such suspicious document with a plurality of fingerprints for documents saved in a database if said source for plagiarism is a database.

5. The method of claim 1, wherein said method further comprises using said split sentences as a query to the web using a suitable search engine for getting 10 results, looping through such 10 results, adding a hit on each duplicated URL, and displaying the 10 results with the highest number of hits if said source for plagiarism is the web.

6. The method of claim 1, wherein said method further comprises entering an original document and a suspicious document if said source for plagiarism is a direct source.

7. The method of claim 1, wherein said synonyms can be retrieved from either a conventional synonym resource or entered by the user.

8. A computer-readable medium storing a set of computer-readable instructions, that as a result of being executed by a computer, instruct the computer to perform the method as claimed in claim 1.
